(19) United States
(12) Patent Application Publication
(10) Pub. No.: US 2025/0052984 A1
(43) Pub. Date: Feb. 13, 2025

(54) OPTICAL SYSTEM AND DISPLAY APPARATUS

(71) Applicant: Beijing Zitiao Network Technology Co., Ltd., Beijing (CN)

(72) Inventors: Ling FU, Beijing (CN); Xin LI, Beijing (CN); Hsin-Yi HU, Beijing (CN); Jiangsheng YANG, Beijing (CN)

(21) Appl. No.: 18/797,283

(22) Filed: Aug. 7, 2024

(30) Foreign Application Priority Data
Aug. 8, 2023 (CN) 202310994953.3

(51) Int. Cl. G02B 17/08

(52) U.S. Cl. CPC G02B 17/0856

(57) ABSTRACT

An optical system and a display apparatus are provided. The optical system includes: a lens component, a transflective film, a reflective polarization layer, and a phase retardation film. The lens component includes at least two lenses including a first surface, a second surface, a third surface and a fourth surface arranged sequentially; the transflective film is on a side of the first surface away from the second surface; the reflective polarization layer is between the second surface and the third surface; absolute values of curvature radii of the first surface and the second surface are both less than that of the fourth surface; a ratio of the curvature radius of the first surface to that of the second surface is 0.5 to 1.25; and an absolute value ratio of a conic constant of the first surface to that of the second surface is no greater than 0.4.

### CROSS-REFERENCE TO RELATED APPLICATION

The present application claims priority to Chinese Patent Application No. 202310994953.3, filed on Aug. 8, 2023, the disclosure of which is incorporated herein in its entirety as part of the present application.

### TECHNICAL FIELD

The present disclosure relates to an optical system and a display apparatus.

### BACKGROUND

The imaging principle of a head-mounted display optical system is equivalent to that of a magnifying glass, in which an object (e.g., an image source or video source) is located in a focal plane in object space of an optical lens (e.g., located within 1× focal length), and a human eye located on the other side of the lens may observe an upright magnified virtual image through the lens. Usually, the closer the object is to the focal plane of the lens, or the shorter the focal length of the lens, the greater the magnification; in addition, the shorter the focal length of the lens, the shorter the tube length may be.

A single-piece convex lens is the simplest magnifying glass and was firstly used for imaging in a head-mounted display system. Subsequently, the demand for weight reduction and tube length reduction, development of optical fabrication technology, and advancement of optical material technology promote application of the Fresnel lens and the folded optical system (Pancake) in the head-mounted display optical system.

### SUMMARY

The present disclosure provides an optical system and a display apparatus.

An embodiment of the present disclosure provides an optical system, which includes: a lens component, a transflective film, a reflective polarization layer, and a phase retardation film. The lens component includes at least two lenses; the at least two lenses including a first surface, a second surface, a third surface and a fourth surface arranged sequentially along a direction of an optical axis of the lens component; and the second surface and the third surface having a same surface type parameter; the transflective film is located on a side of the first surface of the lens component away from the second surface of the lens component; the reflective polarization layer is located between the second surface and the third surface of the lens component; the phase retardation film is located on a side of the transflective film that faces the second surface. Light transmitted through the transflective film and then incident on the lens component is configured to be folded back between the transflective film and the reflective polarization layer, and exit from the reflective polarization layer; the third surface and the fourth surface are two surfaces of a same lens; the first surface is a convex surface, the second surface is a concave surface, the third surface is a convex surface, the fourth surface is a concave surface; an absolute value of a curvature radius of the first surface and an absolute value of a curvature radius of the second surface are both less than an absolute value of a curvature radius of the fourth surface; a ratio of the curvature radius of the first surface to the curvature radius of the second surface is 0.5 to 1.25; and an absolute value ratio of a conic constant of the first surface to a conic constant of the second surface is no greater than 0.4.

For example, according to an embodiment of the present disclosure, a distance between two intersection points where the first surface and the second surface intersect with the optical axis is a first distance, a distance between two intersection points where the third surface and the fourth surface intersect with the optical axis is a second distance, the first distance is greater than the second distance; and a ratio of the first distance to a focal length of the optical system is 0.45 to 0.8.

For example, according to an embodiment of the present disclosure, a ratio of the curvature radius of the first surface to a focal length of the optical system is −1.5 to −2.5, and the conic constant of the first surface is −10 to 10; a ratio of the curvature radius of the second surface to the focal length and a ratio of a curvature radius of the third surface to the focal length are both −2 to −3, and the conic constant of the second surface and a conic constant of the third surface are both −50 to −30; a ratio of the curvature radius of the fourth surface to the focal length is −4.5 to −6.5, and a conic constant of the fourth surface is 15 to 35.

For example, according to an embodiment of the present disclosure, a ratio of the second distance to the focal length of the optical system is 0.12 to 0.25.

For example, according to an embodiment of the present disclosure, a ratio of an aperture of the lens component to a focal length of the optical system is 2 to 3.

For example, according to an embodiment of the present disclosure, a ratio of a total track length of the optical system to a focal length of the optical system is 0.8 to 1.

For example, according to an embodiment of the present disclosure, the phase retardation film is located between the reflective polarization layer and the transflective film, or located on a side of the reflective polarization layer away from the transflective film.

For example, according to an embodiment of the present disclosure, the optical system further includes: a linear polarization film, located on a side of the reflective polarization layer away from the transflective film.

For example, according to an embodiment of the present disclosure, the lens component includes a first lens, a second lens and a third lens arranged sequentially along the direction of the optical axis; the first lens includes the first surface, the second lens includes the second surface, the third lens includes the third surface and the fourth surface; the first lens further includes a fifth surface opposite to the first surface, the second lens further includes a sixth surface opposite to the second surface; the fifth surface and the sixth surface have a same surface type parameter, the fifth surface and the sixth surface are both flat surfaces, or an absolute value of a curvature radius of the fifth surface in at least one direction is greater than an absolute value of a curvature radius of other surfaces; the phase retardation film is located on the fifth surface or the sixth surface.

For example, according to an embodiment of the present disclosure, the absolute value of the curvature radius in the at least one direction of the fifth surface is greater than 100 millimeters.

For example, according to an embodiment of the present disclosure, a distance between two intersection points where two surfaces of the first lens intersect with the optical axis is a third distance, a distance between two intersection points where two surfaces of the second lens intersect with the optical axis is a fourth distance, a distance between two intersection points where two surfaces of the third lens intersect with the optical axis is the second distance, and the second distance and the fourth distance are both less than the third distance.

For example, according to an embodiment of the present disclosure, a ratio of a sum of the third distance and the fourth distance to the first distance is 0.9 to 1.1.

For example, according to an embodiment of the present disclosure, a ratio of the third distance to the focal length is 0.35 to 0.5, and a ratio of the fourth distance to the focal length is 0.1 to 0.3.

For example, according to an embodiment of the present disclosure, a ratio of a center thickness to an edge thickness of the first lens is no less than 0.5 and no greater than 3, and a ratio of an edge thickness to a center thickness of the second lens is no less than 0.5 and no greater than 2.

For example, according to an embodiment of the present disclosure, an exit pupil distance of the optical system is 12 millimeters to 20 millimeters.

For example, according to an embodiment of the present disclosure, the first lens and the second lens are made of a same material, and a material of the third lens is different from the material of the second lens.

For example, according to an embodiment of the present disclosure, the lens component includes a first lens and a second lens arranged sequentially along the direction of the optical axis; the first lens includes the first surface and the second surface, and the second lens includes the third surface and the fourth surface; the phase retardation film is located between the reflective polarization layer and the transflective film, or located on a side of the reflective polarization layer away from the second surface.

For example, according to an embodiment of the present disclosure, the phase retardation film is located between the reflective polarization layer and the transflective film; and the reflective polarization layer is configured to reflect linearly polarized light of one characteristic and transmit linearly polarized light of another characteristic; or, the phase retardation film is located on a side of the reflective polarization layer away from the second surface, and the reflective polarization layer includes a cholesteric liquid crystal layer.

An embodiment of the present disclosure provides a display apparatus, which includes a display screen and any optical system as mentioned above, the optical system is located on a display side of the display screen, and the second surface is located on a side of the first surface away from the display screen.

### BRIEF DESCRIPTION OF DRAWINGS

In order to more clearly illustrate the technical solutions of the embodiments of the present disclosure, the accompanying drawings of the embodiments will be briefly introduced below, it is obvious that the accompanying drawings in the following description merely relate to some embodiments of the present disclosure, but not the limitations of the present disclosure.

FIG. 1 is a cross-sectional view of an optical system provided by an example according to an embodiment of the present disclosure.

FIG. 2 is an optical path diagram when the optical system shown in FIG. 1 is applied to the display apparatus.

FIG. 3 is a spot diagram of the optical system shown in FIG. 1.

FIG. 4 is a curve chart of a size of a diffuse spot of the optical system shown in FIG. 1 changing with gaze point.

FIG. 5 is a distortion diagram of the optical system shown in FIG. 1.

FIG. 6 to FIG. 9 are cross-sectional views of optical systems provided by different examples according to the embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

The present disclosure provides an optical system and a display apparatus. The optical system includes a lens component, a transflective film, a reflective polarization layer, and a phase retardation film. The lens component includes at least two lenses; the at least two lenses include a first surface, a second surface, a third surface and a fourth surface arranged sequentially along a direction of an optical axis of the lens component; the second surface and the third surface have a same surface type parameter; the transflective film is located on a side of the first surface of the lens component away from the second surface; the reflective polarization layer is located on a side of the second surface of the lens component away from the first surface; and the phase retardation film is located on a side of the transflective film that faces the second surface. Light transmitted through the transflective film and then incident on the lens component is configured to be folded back between the transflective film and the reflective polarization layer, and exit from the reflective polarization layer; the third surface and the fourth surface are two surfaces of a same lens; the first surface is a convex surface; the second surface is a concave surface; the third surface is a convex surface; the fourth surface is a concave surface; an absolute value of a curvature radius of the first surface and an absolute value of a curvature radius of the second surface are both less than an absolute value of a curvature radius of the fourth surface; a ratio of the curvature radius of the first surface to the curvature radius of the second surface is 0.5 to 1.25; and an absolute value ratio of a conic constant of the first surface to a conic constant of the second surface is no greater than 0.4.

In the optical system provided by the present disclosure, the lens component is set to include at least four surfaces, two surfaces are respectively provided with a transflective film and a reflective polarization layer to realize the folding of light; curvature radius relationships of the first surface, the second surface, the third surface and the fourth surface are set, and conic constant relationships of the first surface and the second surface are set, thereby providing an optical system having characteristics of ultra-short focus and large field of view.

The optical system and the display apparatus provided by the embodiments of the present disclosure are described below with reference to the drawings.

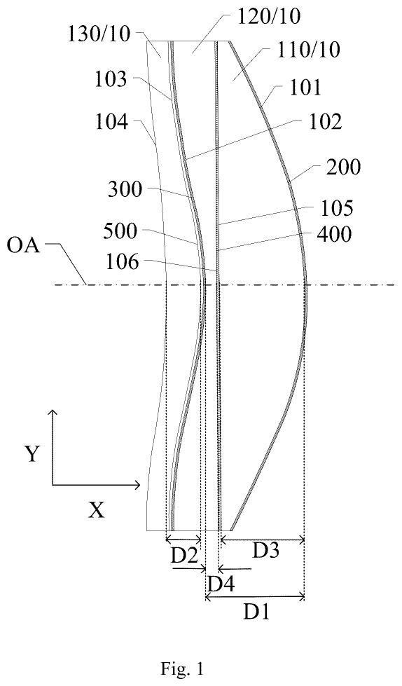

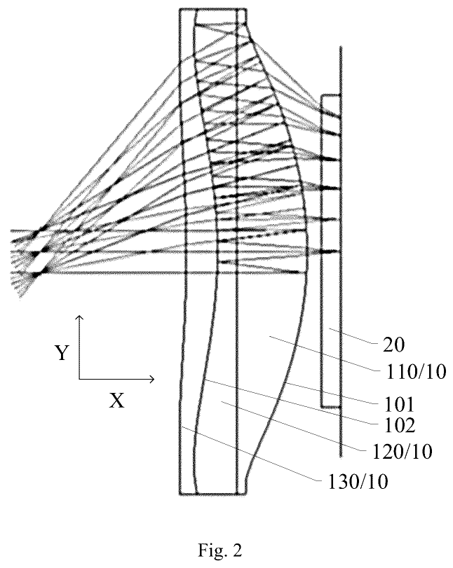

FIG. 1 is a cross-sectional view of an optical system provided by an example according to an embodiment of the present disclosure. FIG. 2 is an optical path diagram when the optical system shown in FIG. 1 is applied to the display apparatus.

As shown in FIG. 1, the optical system includes a lens component 10, a transflective film 200, a reflective polarization layer 300, and a phase retardation film 400.

As shown in FIG. 1, the lens component 10 includes at least two lenses; the at least two lenses include a first surface 101, a second surface 102, a third surface 103 and a fourth surface 104 arranged sequentially along a direction of an optical axis OA of the lens component 10; and the second surface 102 and the third surface 103 have the same surface type parameter. The third surface 103 and the fourth surface 104 are two surfaces of the same lens; the first surface 101 is a convex surface; the second surface 102 is a concave surface; the third surface 103 is a convex surface; and the fourth surface 104 is a concave surface. For example, the lens including the third surface 103 and the fourth surface 104 may be a convex lens. For example, at least one of the first surface 101, the second surface 102, the third surface 103 and the fourth surface 104 includes a spherical surface, an aspherical surface, and a freeform surface. For example, the first surface 101 is an aspherical surface. For example, the second surface 102 and the third surface 103 are both aspherical surfaces. For example, the second surface 102 and the third surface 103 have the same surface type parameter as mentioned above refers to that the second surface may be almost completely attached to the third surface without considering presence of other film layers between the two.

For example, the optical axis OA is parallel to an X direction shown in the diagram. For example, FIG. 1 schematically shows that the second surface 102 may be bonded to the third surface 103, which may improve the compactness of the optical system while alleviating a ghost problem. But it is not limited thereto; and an air gap may also be provided between the second surface and the third surface, to improve design freedom of the optical system.

As shown in FIG. 1, the transflective film 200 is located on the side of the first surface 101 of the lens component 10 away from the second surface 102. For example, the transflective film 200 may be provided on the first surface 101. For example, the transflective film 200 may be plated on the first surface 101.

For example, as shown in FIG. 1, the transflective film 200 is configured to transmit a portion of light and reflect another portion of light. For example, the transflective film 200 may include at least one film layer; for example, the thickness of each film layer may be 10 nanometers to 200 nanometers. For example, the transflective film 200 may have transmittance of 50% and reflectance of 50%. For example, the transflective film 200 may have transmittance of 60% and reflectance of 40%. For example, the transflective film 200 may have transmittance of 65% and reflectance of 35%. The optical system provided by the present disclosure is not limited thereto, and transmittance and reflectance of the transflective film may be set according to product requirements.

As shown in FIG. 1, the reflective polarization layer 300 is located between the second surface 102 and the third surface 103 of the lens component 10. For example, the reflective polarization layer 300 may be provided on the second surface 102. For example, the reflective polarization layer 300 may be a polarization reflective film; and the reflective polarization layer 300 is configured to reflect linearly polarized light of one characteristic and transmit linearly polarized light of another characteristic.

For example, as shown in FIG. 1, the reflective polarization layer 300 has functions as follows: the film layer plane has a transmission axis direction, and incident light has transmittance of a polarization component (e.g., s-linearly polarized light) parallel to the transmission axis direction greater than transmittance of a polarization component (e.g., p-linearly polarized light) perpendicular to the transmission axis direction, and reflectance of the polarization component (e.g., s-linearly polarized light) parallel to the transmission axis direction less than reflectance of the polarization component (e.g., p-linearly polarized light) perpendicular to the transmission axis direction. For example, the reflective polarization layer 300 may also be referred to as a polarization beam splitter film. For example, transmittance of polarized light parallel to the transmission axis direction of the reflective polarization layer 300 is no less than 85%, for example, no less than 90%, for example, no less than 95%, for example, no less than 98%; and reflectance of polarized light perpendicular to the transmission axis direction of the reflective polarization layer 300 is no less than 85%, for example, no less than 90%, for example, no less than 95%, for example, no less than 98%. For example, the reflective polarization layer 300 may include a dual brightness enhancement film (DBEF).

As shown in FIG. 1, the phase retardation film 400 is located on the side of the transflective film 200 that faces the second surface 102. For example, the phase retardation film 400 is located between the reflective polarization layer 300 and the transflective film 200. For example, the phase retardation film 400 is configured to cause the transmitted light to implement transition between a circularly polarized state and a linearly polarized state. For example, the phase retardation film 400 may be a ¼ wave plate. For example, the material of the phase retardation film 400 may include liquid crystal polymer or polycarbonate. For example, the phase retardation film 400 has characteristics below: the film layer plane has a direction with the lowest refractive index and a direction with the highest refractive index, which are respectively a fast axis and a slow axis; polarized light parallel to the slow axis after passing through the phase retardation film 400 is delayed by ¼ wavelength as compared with polarized light parallel to the fast axis after passing through the phase retardation film 400.

For example, as shown in FIG. 1, an included angle between the slow axis of the phase retardation film 400 and the transmission axis of the reflective polarization layer 300 is 45 degrees.

In some examples, as shown in FIG. 1, the optical system further includes a linear polarization film 500 located on the side of the reflective polarization layer 300 away from the transflective film 200.

For example, as shown in FIG. 1, the transmission axis of the linear polarization film 500 coincides with the transmission axis of the reflective polarization layer 300; for example, the linear polarization film 500 may be further used for filtering out other stray light, allowing only polarized light (e.g., s-linearly polarized light) passing through the linear polarization film 500 to enter a human eye. For example, the linear polarization film 500 may adopt a three-layer structure; a middle layer in the three-layer structure may be made of polyvinyl alcohol (PVA) added with dichroic molecules; at least one layer on both sides of the middle layer in the three-layer structure may be made of triacetate cellulose (TAC); and a total thickness of the three-layer structure may be 40 microns to 200 microns.

For example, as shown in FIG. 1, the reflective polarization layer 300 is attached to the second surface 102; and the linear polarization film 500 is attached to the surface of the reflective polarization layer 300 or attached to the third surface 103. For example, an anti-reflection film may be provided on the side of the fourth surface 104 away from the first surface 101.

As shown in FIG. 1 and FIG. 2, light, for example, light emitted from the display panel 20, transmitted through the transflective film 200, and then incident on the lens component 10, is configured to be folded back between the transflective film 200 and the reflective polarization layer 300 and exit from the reflective polarization layer 300, to realize an ultra-short focal folded optical path (Pancake).

For example, as shown in FIG. 1 and FIG. 2, the folded optical path has a principle as follows: a wave plate may be provided on a light emergent side of the display screen 20 that is located on the side of the first surface 101 that is away from the second surface 102; image light emitted from the display screen is converted into right-handed circularly polarized light after passing through the wave plate; the right-handed circularly polarized light is incident on the transflective film 200; and the right-handed circularly polarized light keeps a polarized state unchanged after being transmitted by the transflective film 200. The right-handed circularly polarized light reaches the phase retardation film 400, the right-handed circularly polarized light incident on the phase retardation film 400 is converted into p-linearly polarized light, the p-linearly polarized light is reflected back by the reflective polarization layer 300 to the phase retardation film 400, where a first reflection occurs. Afterwards, the p-linearly polarized light is converted into right-handed circularly polarized light after passing through the phase retardation film 400; the right-handed circularly polarized light reaches the transflective film 200 and is reflected at the transflective film 200, where a second reflection occurs. Because of half-wave loss, the reflected light changes from right-handed circularly polarized light to left-handed circularly polarized light. The left-handed circularly polarized light is transformed into s-linearly polarized light through the phase retardation film 400, and then the s-linearly polarized light is transmitted through the reflective polarization layer 300 and the linear polarization film 500 to a human eye.

The above-described folded optical path may change a polarized state of light propagating between the reflective polarization layer and the transflective film, implementing folding of a light path, so that an original focal length of the optical system is folded because of, for example, two reflections added by providing the reflective polarization layer, the phase retardation film, and the transflective film as described above, which greatly compresses space required between the human eye and the optical system, resulting in a smaller and lighter volume of the optical system.

As shown in FIG. 1, the absolute value of the curvature radius of the first surface 101 and the absolute value of the curvature radius of the third surface 103 are both less than the absolute values of the curvature radius of the fourth surface 104. The ratio of the curvature radius of the first surface 101 to the curvature radius of the second surface 102 is 0.5 to 1.25, and the absolute value ratio of the conic constant of the first surface 101 to the conic constant of the second surface 102 is no greater than 0.4.

In some examples, as shown in FIG. 1, the distance between two intersection points where the first surface 101 and the second surface 102 intersect with the optical axis OA is a first distance D1; the distance between two intersection points where the third surface 103 and the fourth surface 104 intersect with the optical axis OA is a second distance D2; the first distance D1 is greater than the second distance D2; and the ratio of the first distance D1 to the focal length is 0.45 to 0.8.

The optical system provided by the embodiment of the present disclosure is an optical system adopting the folded optical path (Pancake); in the optical system, the lens component is set to include at least four surfaces, two surfaces are respectively provided with the transflective film and the reflective polarization layer to realize the folding of light; curvature radius relationships of the first surface, the second surface, the third surface and the fourth surface are set, conic constant relationships of the first surface and the second surface are set, and meanwhile, distance relationships between the respective surfaces as well as ratio relationships with the focal length of the optical system are set, thereby providing an optical system having characteristics of ultra-short focus and large field of view.

As compared with a single lens provided with only two surfaces, the optical system provided by the present disclosure is provided with at least four surfaces, which is favorable for improving degree of freedom in design of the surface type parameter of the optical system, so as to enhance display performances including clarity, aberration correction, and increased field of view, etc.

By providing the reflective polarization layer between the second surface and the fourth surface, light exit from the reflective polarization layer is refracted through at least one air-medium interface before being incident on the human eye, which is favorable for deflecting light and improving the field of view.

For example, as shown in FIG. 1, the ratio of the curvature radius of the first surface 101 to the curvature radius of the second surface 102 is 0.7 to 1, and the absolute value ratio of the conic constant of the first surface 101 to the conic constant of the second surface 102 is no greater than 0.35. For example, the ratio of the curvature radius of the first surface 101 to the curvature radius of the second surface 102 is 0.6 to 1.2, and the absolute value ratio of the conic constant of the first surface 101 to the conic constant of the second surface 102 is no greater than 0.3. For example, the ratio of the curvature radius of the first surface 101 to the curvature radius of the second surface 102 is 0.8 to 1.1, and the absolute value ratio of the conic constant of the first surface 101 to the conic constant of the second surface 102 is no greater than 0.25.

For example, as shown in FIG. 1, the ratio of the first distance D1 to the focal length is 0.5 to 0.6. For example, the ratio of the first distance D1 to the focal length is 0.55 to 0.75. For example, the ratio of the first distance D1 to the focal length is 0.48 to 0.7.

In some examples, as shown in FIG. 1 and FIG. 2, the ratio of the curvature radius of the first surface 101 to the focal length is −1.5 to −2.5, and the conic constant of the first surface 101 is −10 to 10; ratios of the curvature radii of the second surface 102 and the third surface 103 to the focal length are both −2 to −3, and the conic constants of the second surface 102 and the third surface 103 are both −50 to −30; the ratio of the curvature radius of the fourth surface 104 to the focal length is −4.5 to −6.5, and the conic constant of the fourth surface 104 is 15 to 35.

In some examples, as shown in FIG. 1 and FIG. 2, the ratio of the second distance D2 to the focal length is 0.12 to 0.25.

In some examples, as shown in FIG. 1 and FIG. 2, the ratio of a total track length (TTL) of the optical system to the focal length is 0.8 to 1.

In some examples, as shown in FIG. 1, the ratio of an aperture of the lens component 10 to the focal length of the optical system is 2 to 3. The above-described aperture of the lens component 10 refers to an effective clear aperture, for example, the maximum aperture allowing light to pass through the lens component 10, and the aperture is determined by the maximum luminous flux of the lens component 10.

For example, as shown in FIG. 1, the exit pupil distance of the optical system is 12 millimeters to 20 millimeters.

By setting the ratio relationships between the curvature radii of the respective surfaces to the focal length of the optical system, setting the conic constants of the respective surfaces, setting the ratio relationships between distances of different surfaces and the focal length, setting the ratio relationships between the total track length and the focal length, and setting the ratio relationships between the aperture of the lens component and the focal length of the optical system, the optical system may have a suitable exit pupil distance while having a display effect of ultra-short focal length and large field of view, which improves user experience.

For example, as shown in FIG. 1, the ratio of the curvature radius of the first surface 101 to the focal length is −1.8 to −2, and the conic constant of the first surface 101 is −5 to 5. For example, the ratio of the curvature radius of the first surface 101 to the focal length is −1.6 to −2.3, and the conic constant of the first surface 101 is −7 to 1. For example, the ratio of the curvature radius of the first surface 101 to the focal length is −1.9 to −2.4, and the conic constant of the first surface 101 is −1 to 8. The ratio of the curvature radius of the first surface 101 to the focal length is −1.7 to −2.2, and the conic constant of the first surface 101 is −3 to 7.

For example, as shown in FIG. 1, the ratios of the curvature radii of the second surface 102 and the third surface 103 to the focal length are both −2.5 to −2.8, and the conic constants of the second surface 102 and the third surface 103 are both −40 to −35. For example, the ratios of the curvature radii of the second surface 102 and the third surface 103 to the focal length are both −2.3 to −2.7, and the conic constants of the second surface 102 and the third surface 103 are both −45 to −37. For example, the ratios of the curvature radii of the second surface 102 and the third surface 103 to the focal length are both −2.2 to −2.6, and the conic constants of the second surface 102 and the third surface 103 are both −48 to −32.

For example, as shown in FIG. 1, the ratio of the curvature radius of the fourth surface 104 to the focal length is −5 to −6, and the conic constant of the fourth surface 104 is 20 to 30. For example, the ratio of the curvature radius of the fourth surface 104 to the focal length is −4.8 to −5.5, and the conic constant of the fourth surface 104 is 18 to 25. For example, the ratio of the curvature radius of the fourth surface 104 to the focal length is −4.8 to −6.2, and the conic constant of the fourth surface 104 is 22 to 33.

For example, as shown in FIG. 1, the ratio of the second distance D2 to the focal length is 0.15 to 0.2. The ratio of the second distance D2 to the focal length is 0.18 to 0.24. The ratio of the second distance D2 to the focal length is 0.17 to 0.23.

For example, as shown in FIG. 1, the second distance D2 may be the center thickness of the lens including the third surface 103 and the fourth surface 104.

For example, as shown in FIG. 1, the ratio of the total track length (TTL) of the optical system to the focal length may be 0.85 to 1. For example, the ratio of the total track length of the optical system to the focal length may be 0.8 to 0.95. For example, the ratio of the total track length of the optical system to the focal length may be 0.89 to 0.9. For example, the above-described total track length may refer to the axial distance between the highest point on the fourth surface that is closest to the human eye in the optical system and the display surface of the display panel. The highest point on the fourth surface includes an edge sagittal height of the lens component 10 that is on the fourth surface side.

For example, as shown in FIG. 1, the ratio of the aperture of the lens component 10 to the focal length is 2.2 to 2.5. For example, the ratio of the aperture of the lens component 10 to the focal length is 2.4 to 2.8. For example, the ratio of the aperture of the lens component 10 to the focal length is 2.25 to 2.6. For example, the ratio of the aperture of the lens component 10 to the focal length is 2.3 to 2.7.

For example, as shown in FIG. 1, the ratio of the total track length of the optical system to the aperture of the lens component 10 is 35%.

For example, as shown in FIG. 1, the exit pupil distance of the optical system is 13 millimeters to 18 millimeters. For example, the exit pupil distance of the optical system is 15 millimeters to 17 millimeters. For example, the exit pupil distance of the optical system is 16 millimeters to 19 millimeters.

For example, as shown in FIG. 1, the field of view of the optical system may be 90 degrees to 110 degrees. For example, the field of view of the optical system may be over 100 degrees.

For example, as shown in FIG. 1, the curvature radius of the above-described surface in the lens component 10 is a curvature radius of a base spherical surface on a surface thereof. The above-described “base spherical surface” refers to a spherical surface serving as a basis for further deformation to form an aspherical surface, and thus, the spherical surface is just the base spherical surface of the aspherical surface. For example, the first surface 101 and the second surface 102 may both be aspherical surfaces, for example, both be even aspheric surface (EVENASPH).

For example, a surface type of the aspherical surface is represented by a numerical formula below:

$$z = \frac{{CY}^{2}}{1 + \sqrt{1 - ( 1 + k ) {C}^{2} {Y}^{2}}} + {\sum }_{i = 2}^{N} {α}_{i} {Y}^{2 i} .$$

For example, in the above-described formula, the height of the aspherical surface along the direction perpendicular to the optical axis is Y, and the distance between a vertex of the aspherical surface and a projection of a position whose height is Y on the aspherical surface on the optical axis is z, that is, z is a coordinate along the direction of the optical axis; C is a curvature (a reciprocal of the curvature radius R), k is a conic constant, αᵢ is a coefficient of each higher-order term, and 2i is the order of aspherical coefficient.

When optimizing the rational configuration of the surface type parameter of the lens component 10 in practice, values such as the curvature radius, the conic constant, the height, and the aspherical coefficient of the surface of the lens component 10 are put into the above-described numerical formula, so that respective optimization parameters that may correct aberrations of the optical system are obtained through optical simulation calculation.

For example, the high-order coefficient of the first surface 101 satisfies: α₄=−1.4e-006, α₆=8e-010, α₈=−8e-011. For example, the high-order coefficient of the second surface 102 satisfies: α₄=−2e-005, α₆=−1.2e-007, α₈=−3.0e-010.

In some examples, as shown in FIG. 1, the lens component 10 includes a first lens 110, a second lens 120 and a third lens 130 arranged sequentially along the direction of the optical axis OA; the first lens 110 includes the first surface 101; the second lens 120 includes the second surface 102; the third lens 130 includes the third surface 103 and the fourth surface 104; the first lens 110 further includes a fifth surface 105 opposite to the first surface 101; the second lens 120 further includes a sixth surface 106 opposite to the second surface 102; the fifth surface 105 and the sixth surface 106 have the same surface type parameter; the fifth surface 105 and the sixth surface 106 are both flat surfaces; and the phase retardation film 400 is located on the fifth surface 105 or the sixth surface 106. For example, the phase retardation film 400 is attached to the fifth surface 105 or the sixth surface 106. For example, the fifth surface 105 and the sixth surface 106 have the same surface type parameter as mentioned above refers to that the fifth surface may be almost completely attached to the sixth surface without considering the presence of other film layers between the two.

The phase retardation film includes the birefringent material; and the phase retardation film is attached to a flat surface having a planar shape, which may improve the flatness of the film material, overcome process challenges caused by curved attaching, and avoid a softening and stretching process of the above-described film material which affects birefringence properties such as optical axis angle and phase delay, so it is easy to maintain fixed phase delay, and is favorable for improving overall optical performance of the optical system, such as clarity, stray light, and field of view, to ensure imaging quality.

For example, as shown in FIG. 1, the transflective film 200 is plated on the first surface 101 of the first lens 110; the phase retardation film 400 is attached to the sixth surface 106 of the second lens 120; and the first lens 110 is attached to the phase retardation film 400. For example, the phase retardation film 400 is attached to the fifth surface 105 of the first lens 110; and the first lens 110 is attached to the sixth surface 106 of the second lens 120. For example, the reflective polarization layer 300 and the linear polarization film 500 are attached to the second surface 102 of the second lens 120; and the third lens 130 is attached to the linear polarization film 500. For example, the first lens 110 is bonded to the second lens 120; and the second lens 120 is bonded to the third lens 130.

For example, as shown in FIG. 1, apertures of the first lens 110, the second lens 120 and the third lens 130 may be substantially equal to each other; for example, ratios of the apertures of the three lenses to the focal length of the optical system are all 2 to 3.

In some examples, as shown in FIG. 1, the distance between two intersection points where the two surfaces of the first lens 110 intersect with the optical axis OA is a third distance D3; the distance between two intersection points where the two surfaces of the second lens 120 intersect with the optical axis OA is a fourth distance D4; the distance between two intersection points where the two surfaces of the third lens 130 intersect with the optical axis OA is the second distance D2; and the second distance D2 and the fourth distance D4 are both less than the third distance D3.

For example, as shown in FIG. 1, the center thickness of the first lens 110 is the third distance D3; and the center thickness of the second lens 120 is the fourth distance D4. For example, the first lens 110 may be a positive lens. For example, the first lens 110 may be a planoconvex lens. For example, the second lens 120 may be a negative lens. For example, the second lens 120 may be a planoconcave lens.

In some examples, as shown in FIG. 1, the ratio of the third distance D3 to the focal length is 0.35 to 0.5; the ratio of the fourth distance D4 to the focal length is 0.1 to 0.3; and the ratio of the second distance D2 to the focal length is 0.12 to 0.25.

For example, as shown in FIG. 1, the ratio of the third distance D3 to the focal length is 0.4 to 0.48; the ratio of the fourth distance D4 to the focal length is 0.15 to 0.25; and the ratio of the second distance D2 to the focal length is 0.15 to 0.2. For example, the ratio of the third distance D3 to the focal length is 0.37 to 0.45; the ratio of the fourth distance D4 to the focal length is 0.12 to 0.2; and the ratio of the second distance D2 to the focal length is 0.2 to 0.23.

In some examples, as shown in FIG. 1, the ratio of the sum of the third distance D3 and the fourth distance D4 to the first distance D1 is 0.9 to 1.1. For example, FIG. 1 schematically shows the impact of the respective film layers on distances between different surfaces of the lens component. In the case where the thicknesses of the respective film layers are relatively thin, the thicknesses of respective film layers may be ignored; and at this time, the sum of the center thickness of the first lens and the center thickness of the second lens may be the above-described first distance.

In some examples, as shown in FIG. 1, the first lens 110 and the second lens 120 are made of the same material; and the material of the third lens 130 is different from the material of the second lens 120, which is favorable for correcting chromatic aberration. For example, refractive indices of the first lens 110 and the second lens 120 may be 1.45 to 1.75. By selecting a greater refractive index for the first lens 110 and the second lens 120, it is favorable for obtaining a greater curvature radius.

The first lens and the second lens are made of the same material, which is convenient for fabricating the optical system.

For example, as shown in FIG. 1, the Abbe numbers of the first lens 110 and the second lens 120 are both greater than 50. For example, the Abbe number of the third lens 130 is different from the Abbe numbers of the first lens 110 and the second lens 120.

For example, as shown in FIG. 1, the material of the first lens 110 and the second lens 120 may be cycloolefin copolymer (COC), for example, resin, with a refractive index of 1.54 and an Abbe number νd of 56. For example, the material of the third lens 130 may be polymethyl methacrylate (PMMA), for example, organic glass, with a refractive index of 1.49 and an Abbe number of 57.2. For example, the material of the third lens 130 may be polystyrene (PS), with a refractive index of 1.59 and an Abbe number of 30.8. Of course, the embodiment of the present disclosure is not limited thereto; the material of the third lens may also be the same as the material of the first lens and the second lens, or the material of the first lens may be different from the material of the second lens.

For example, as shown in FIG. 1, when the aperture of the optical system satisfies a field of view being no less than 100 degrees, the thickness of an edge of at least one lens (a position outside the effective clear aperture) may be reduced, to reduce the weight of the optical system. For example, when the optical system provided by the present disclosure is applied to a display apparatus, the weight of the binocular lens does not exceed 30 grams.

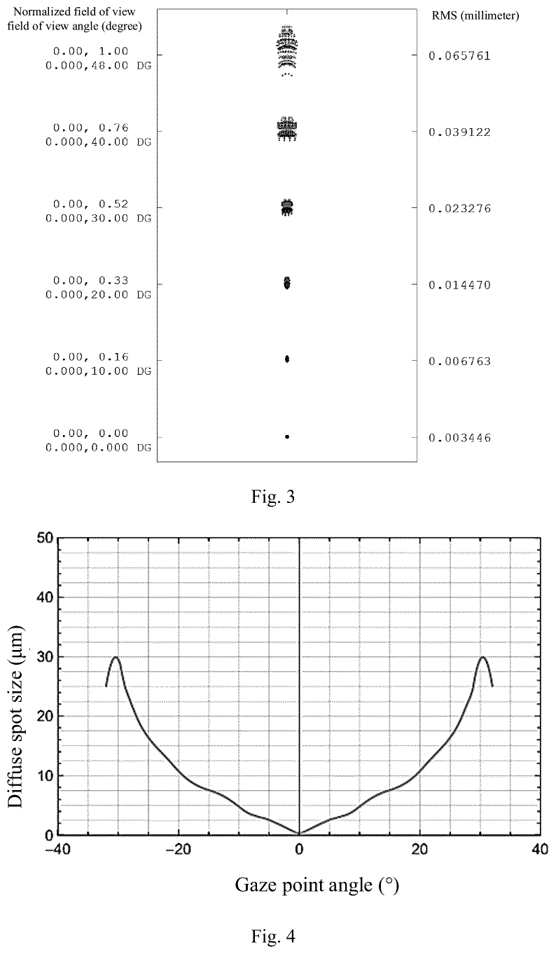

FIG. 3 is a spot diagram of the optical system shown in FIG. 1. FIG. 4 is a curve chart of a size of a diffuse spot, for example, a root mean square (RMS) of the diffuse spot diameter, of the optical system shown in FIG. 1 changing with gaze point. FIG. 3 shows a normalized field of view in the X direction, a normalized field of view in the Y direction, a field of view in the X direction and a field of view in the Y direction, as well as root mean squares (RMSs) of the diffuse spot diameter at different fields of view.

A spot diagram refers to a diffused graph formed by spots distributed in a certain range, in which the spots are intersection points of many rays emitted from a single point passing through an optical system with an image plane that are no longer concentrated at the same point because of aberration; and the spot diagram may be used to evaluate imaging quality of an optical system. FIG. 3 is usually used to evaluate the full field clarity of the optical system, that is, imaging clarity of the full field of view that may be covered by residual sight when a human eye pupil is located at an entrance pupil position on the optical axis and is gazed on the center of the lens (i.e., a zero field of view), which is also referred to as a transient mode. Besides the full field clarity in the mode, gaze point clarity is a more important optical indicator for a head display wearer, for example, the clarity of an image within a certain angular range that may be directly seen (rather than being seen by residual sight) when the eye rotates up, down, left and right.

In the gaze point mode, the eye rotates a certain angle, and the pupil deviates from the center of the optical axis, causing certain deviation from the Z direction and the Y direction of the optical axis, and a certain included angle between a main ray passing through the center of the pupil and the Z axis. For example, a range of the included angle is +35 degrees to take into account the observation habits of the human eye; for example, in the case where a person wants to see an object in front of the person more than 35 degrees beyond the center of the eye, the person will actively turn the head of the person instead of laboriously rotating the eyeball of the person. FIG. 4 shows a relationship between the gaze point clarity and a gaze point angle; a diffuse spot in the central field of view is much smaller than one pixel; and the diameter of the diffuse spot is 16 micrometers when the human eye rotates to 25 degrees.

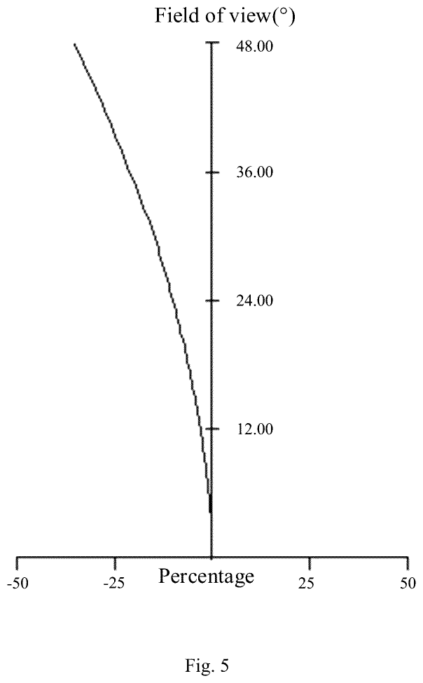

FIG. 5 shows a distortion diagram of the optical system shown in FIG. 1.

For example, as shown in FIG. 5, distortion is a parameter in an optical system, and is one of the important factors limiting the accuracy of optical measurements, which indicates the degree of distortion of an object image formed by the optical system relative to the object. FIG. 5 shows the degree of distortion in the optical system. At a 48° half field of view, the relative distortion of the optical system is no less than-35%, thus, the optical system meets distortion requirements for imaging in general virtual reality products, and the degree of imaging distortion is relatively low. Additionally, distortion correction may be preprocessed in software.

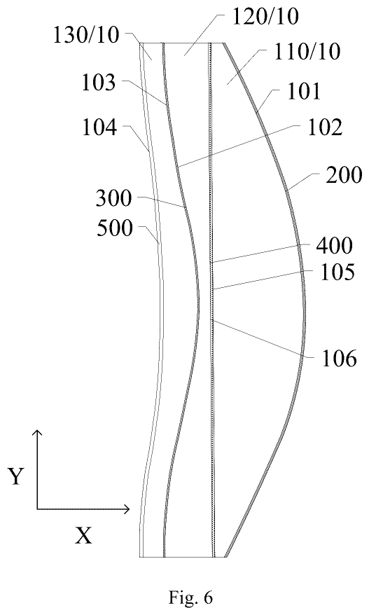

FIG. 6 is a cross-sectional view of an optical system provided by another example according to the embodiment of the present disclosure. The optical system shown in FIG. 6 differs from the optical system shown in FIG. 1 in that the position of the linear polarization film 500 is different. For example, as shown in FIG. 6, the linear polarization film 500 is located on the fourth surface 104. For example, the linear polarization film 500 is attached to the fourth surface. For example, a surface of the linear polarization film 500 that faces the air is subjected to anti-reflection treatment. For example, the surface of the linear polarization film 500 that faces the air may be attached to a moth-eye film. The respective lenses and the respective film layers in the optical system shown in FIG. 6 may have the same features as the corresponding lenses and the corresponding film layers in the optical system shown in FIG. 1, and no details will be repeated here.

For example, as shown in FIG. 6, by attaching the reflective polarization film 300 to the second surface 102 or the third surface 103, and attaching the linear polarization film 500 to the fourth surface 104, problems such as wrinkles, film cracks, or tension caused by thicker film layers may be avoided.

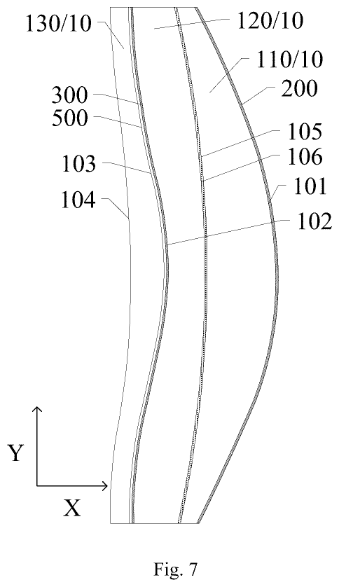

FIG. 7 is a cross-sectional view of an optical system provided by another example according to the embodiment of the present disclosure. The optical system shown in FIG. 7 differs from the optical system shown in FIG. 1 in that the fifth surface and the sixth surface have different surface types.

In some examples, as shown in FIG. 7, the absolute value of the curvature radius of the fifth surface 105 in at least one direction is greater than the absolute value of the curvature radius of other surfaces; and the phase retardation film 400 is located on the fifth surface 105 or the sixth surface 106. For example, the fifth surface 105 and the sixth surface 106 both bend towards a side close to the first surface 101.

In some examples, as shown in FIG. 7, the absolute values of the curvature radii in the at least one direction of the fifth surface 105 and the sixth surface 106 are greater than 100 millimeters. For example, the absolute values of the curvature radii in any direction of the fifth surface 105 and the sixth surface 106 are greater than 100 millimeters. For example, the fifth surface 105 and the sixth surface 106 may be microcurvature surfaces.

For example, as shown in FIG. 7, the ratios of the curvature radii of the fifth surface 105 and the sixth surface 106 to the focal length of the optical system are −8 to −10.

For example, as shown in FIG. 7, when the sixth surface 106 (or the fifth surface 105) used for arranging the phase retardation film 400 in the lens component 10 is a curved surface, in the process of attaching the phase retardation film 400 to the lens component 100, the flat-shaped phase retardation film 400 firstly needs to be stretched appropriately, and then completely attached to the curved sixth surface 106. In the case where the curvature radius of the sixth surface 106 of the lens component 10 is relatively small, for example, when the absolute value thereof is less than 100 millimeters and meanwhile the conic constant is greater than or equal to zero, the phase retardation film 400 may produce wrinkles when stretched and attached to the sixth surface 106; the wrinkles produced by excessively stretching and attaching the phase retardation film 400 may affect accuracy of phase delay of the phase retardation film, and further affect optical performance. In the optical system provided by the present disclosure, by setting the absolute value of the curvature radius of the sixth surface for attaching the phase retardation film greater, the impact of the curved surface type of the sixth surface on performance of the phase retardation film may be reduced.

For example, as shown in FIG. 7, the sixth surface 106 may be a curved surface having a rotational symmetry characteristic. For example, the sixth surface 106 has surface types in two different directions consistent with each other; and the sixth surface 106 has curvature radii in the above-described two different directions equal to each other, for example, both are less than −100 micrometers. For example, the sixth surface 106 may be an aspherical surface.

For example, as shown in FIG. 7, the sixth surface 106 may be a curved surface having an axial symmetry characteristic. For example, the sixth surface 106 has a surface type in one direction different from a surface type in another direction; and the sixth surface 106 has curvature radii in the above-described two directions different from each other, for example, one of the above-described two directions is less than −100 micrometers. For example, the sixth surface 106 may be an ellipsoidal surface. For example, the sixth surface 106 may be a cylindrical surface, that is, the sixth surface 106 is a curved surface in one of the above-described two directions, while the sixth surface 106 is a flat surface in the other direction, that is, a cylindrical surface; the curvature radius in one of the above-described two directions is 0, and the curvature radius in the other direction is not 0.

By setting the shape of the sixth surface to a curved surface having an axial symmetry characteristic, it is favorable for avoiding significant impact on the shape of the phase retardation film during the process of stretching and attaching the phase retardation film.

In some examples, as shown in FIG. 7, the ratio of the center thickness to an edge thickness of the first lens 110 is no less than 0.5 and no greater than 3; and the ratio of an edge thickness to the center thickness of the second lens 120 is no less than 0.5 and no greater than 2. Thus, both the first lens and the second lens reach a reasonable thickness ratio between the center thickness and the edge thickness, which is ensuring injection molding of the first lens and the second lens, reducing stress and making processing easier.

For example, as shown in FIG. 7, the ratio of the center thickness to the edge thickness of the first lens 110 is no greater than 2.8; and the ratio of the edge thickness to the center thickness of the second lens 120 is no greater than 1.5. For example, the ratio of the center thickness to the edge thickness of the first lens 110 is no greater than 2.5; and the ratio of the edge thickness to the center thickness of the second lens 120 is no greater than 1.7. For example, the ratio of the center thickness to the edge thickness of the first lens 110 is no greater than 2.3; and the ratio of the edge thickness to the center thickness of the second lens 120 is no greater than 1.4. For example, the ratio of the center thickness to the edge thickness of the first lens 110 is no greater than 2; and the ratio of the edge thickness to the center thickness of the second lens 120 is no greater than 1.2.

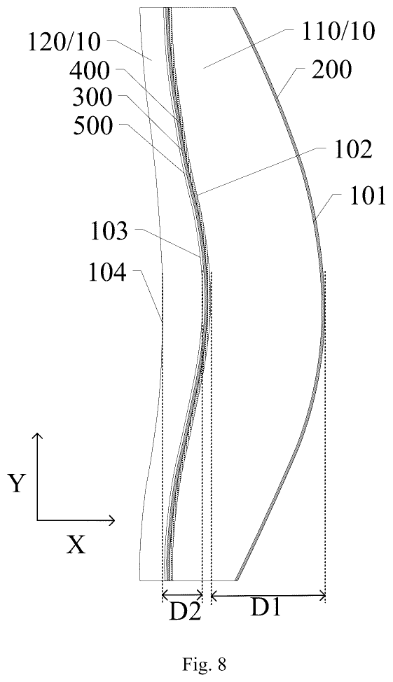

FIG. 8 is a cross-sectional structural schematic diagram of the optical system provided by another example according to the embodiment of the present disclosure. The optical system shown in FIG. 8 differs from the optical system shown in FIG. 1 in that the number of lenses included in the lens component 10 is different, and the position of the phase retardation film 400 is different.

In some examples, as shown in FIG. 8, the lens component 10 includes a first lens 110 and a second lens 120 arranged sequentially along the direction of the optical axis; the first lens 110 includes the first surface 101 and the second surface 102; and the second lens 120 includes the third surface 103 and the fourth surface 104. The first surface, the second surface, the third surface and the fourth surface in the example have the same features as the first surface, the second surface, the third surface and the fourth surface in the lens component provided by the above-described example, and no details will be repeated here.

Only the first lens and the second lens are provided in the lens component, which facilitates fabricating the lens component.

For example, as shown in FIG. 8, the center thickness of the first lens 110 is the first distance D1; and the center thickness of the second lens 120 may be the second distance D2. The first distance and the second distance in the example may have the same features as the first distance and the second distance in the above-described example, and no details will be repeated here.

For example, as shown in FIG. 8, the transflective film 200 may be plated on the first surface 101; the phase retardation film 400, the reflective polarization layer 300, and the linear polarization film 500 may be attached between the second surface 102 and the third surface 103; and the first lens 110 is bonded to the second lens 120. The transflective film in the example has the same features as the transflective film in the above-described example, and no details will be repeated here.

For example, as shown in FIG. 8, the phase retardation film 400 may be made of liquid crystal polymer; the polymer may implement the same performance as the traditional optical film materials such as a quarter wave plate (with a conventional thickness of about 50 μm) at a very thin film thickness (1 μm to 5 μm); because the thickness of the film is thin, it has a high degree of adaptability to different curved surfaces, and is easy to mold according to the curved surface. In addition, the liquid crystal polymer is a cross-linked system, with molecules connected by chemical bonds with high modulus; when subjected to tension after attaching, it has only clastic deformation, without intense effects such as molecular extension and rearrangement that affect optical anisotropy. Therefore, the phase retardation film made of liquid crystal polymer is attached to a curved surface, resulting in less optical offset. The phase retardation film made of the above-described liquid crystal polymer may be attached to a surface with a less curvature radius absolute value, for example, less than 100 millimeters, so as to improve the degree of freedom of the curvature radius of the surface in the lens component, which is further favorable for improving the image quality of the optical system, for example, including indicators such as clarity, distortion, and chromatic dispersion, etc.

The reflective polarization layer and the linear polarization film in the optical system provided by the example may have the same features as the reflective polarization layer and the linear polarization film in the optical system provided by the above-described example, and no details will be repeated here.

In the optical systems in different examples shown in FIG. 1 to FIG. 8, the phase retardation film 400 is always located between the reflective polarization layer 300 and the transflective film 200; and the reflective polarization layer 300 in the respective examples shown in FIG. 1 to FIG. 8 may be made of the same material.

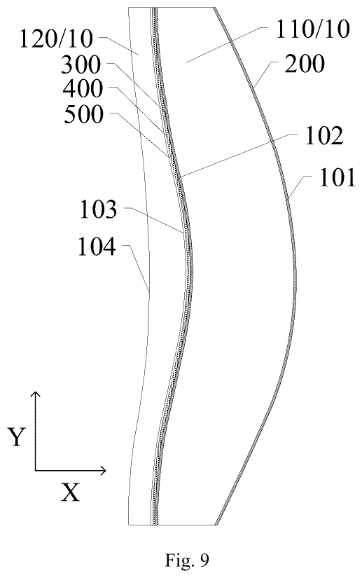

FIG. 9 is a cross-sectional structural schematic diagram of the optical system provided by another example according to the embodiment of the present disclosure. The optical system shown in FIG. 9 differs from the optical system shown in FIG. 8 in that the positional relationship between the phase retardation film 400 and the reflective polarization layer 300 is different, and the reflective polarization layers 300 in the optical system shown in FIG. 8 and the optical system shown in FIG. 9 have different characteristics.

In some examples, as shown in FIG. 9, the phase retardation film 400 is located on the side of the reflective polarization layer 300 away from the transflective film 200.

For example, as shown in FIG. 9, the reflective polarization layer 300 includes a cholesteric liquid crystal layer. The cholesteric liquid crystal layer may reflect circularly polarized light and transmit circularly polarized light. Referring to the folded optical path principle as mentioned above, the cholesteric liquid crystal layer 300 is provided between the phase retardation film 400 and the transflective film 200. The light emergent side of the display screen located on a side of the first lens 110 away from the second lens 120 may be provided with a wave plate; image light emitted from the display screen is converted into right-handed circularly polarized light after passing through the wave plate; the right-handed circularly polarized light is incident on the transflective film 200; and the right-handed circularly polarized light keeps a polarized state unchanged after passing through the transflective film 200. The right-handed circularly polarized light is reflected back to the transflective film 200 after passing through the cholesteric liquid crystal layer 300, where a first reflection occurs; the right-handed circularly polarized light is reflected at the transflective film 200, where a second reflection occurs. Because of half-wave loss, the reflected light changes from right-handed circularly polarized light to left-handed circularly polarized light; the left-handed circularly polarized light is transmitted by the cholesteric liquid crystal layer 300, then reaches the phase retardation film 400, and is converted into s-polarized light by the phase retardation film 400; then, the s-linearly polarized light is transmitted by the linear polarization film 500 and is exited towards the human eye.

FIG. 2 schematically shows a partial structural schematic diagram of a display apparatus provided by another embodiment of the present disclosure.

As shown in FIG. 2, the display apparatus includes a display screen 20 and an optical system in any one of the above-described examples. FIG. 2 schematically shows that the optical system is the optical system shown in FIG. 1, but it is not limited thereto; and the optical system may also be the optical system provided by any one of the examples in FIG. 7 to FIG. 10.

As shown in FIG. 2, the optical system is located on a display side of the display screen 20; and the second surface 102 is located on a side of the first surface 101 away from the display screen 20.

For example, as shown in FIG. 2, the display surface of the display screen 20 is located on a focal plane of a light incident side of the optical system.

For example, as shown in FIG. 2, the display screen 20 may further include a plurality of sub-pixels (not shown) and a microlens array (not shown) located on a light emergent side of the plurality of sub-pixels. For example, the microlens array includes a plurality of microlenses, for example, the microlens may be a spherical lens or an aspherical lens. For example, the curvature radius of a surface of each microlens may be the same, but at least some microlenses may be eccentric microlenses, for example, having a convex surface vertex deviate from a center of a sub-pixel corresponding thereto; different microlenses have different included angles between optical axes thereof and a normal of a light emitting surface of the display screen, so that light emitted from the sub-pixel has light intensity redistributed after passing through the microlens, making maximum light intensity consistent with a chief ray direction of different fields of view in the optical system.

For example, as shown in FIG. 2, the display screen 20 may be a silicon-based organic light emitting diode display screen with extremely high pixels per inch (PPI); the optical system has performance of high clarity and large field of view; the diffuse spot of the optical system in the central field of view is smaller than a size of one sub-pixel (at a micrometer level), and the full field of view may exceed 100 degrees.

For example, as shown in FIG. 2, the display screen 20 may be any type of display screen, for example, a liquid crystal display screen, an inorganic light emitting diode display screen, a quantum dot display screen, a projector (e.g., a LCOS mini projector), etc.

For example, the display apparatus may be a virtual reality (VR) display apparatus. For example, the virtual reality display apparatus may be a display apparatus that adopts ultra-short focus folded optical path.

For example, the display apparatus may be a near eye display apparatus; the near eye display apparatus may be a wearable VR helmet, VR glasses, etc.; and the embodiment of the present disclosure is not limited thereto.

The following statements should be noted:
(1) In the accompanying drawings of the embodiments of the present disclosure, the drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. An optical system, comprising:
a lens component, comprising at least two lenses; the at least two lenses comprising a first surface, a second surface, a third surface and a fourth surface arranged sequentially along a direction of an optical axis of the lens component; and the second surface and the third surface having a same surface type parameter;
a transflective film, located on a side of the first surface of the lens component away from the second surface of the lens component;
a reflective polarization layer, located between the second surface and the third surface of the lens component;
a phase retardation film, located on a side of the transflective film that faces the second surface;
wherein light transmitted through the transflective film and then incident on the lens component is configured to be folded back between the transflective film and the reflective polarization layer, and exit from the reflective polarization layer;
the third surface and the fourth surface are two surfaces of a same lens; the first surface is a convex surface, the second surface is a concave surface, the third surface is a convex surface, the fourth surface is a concave surface; an absolute value of a curvature radius of the first surface and an absolute value of a curvature radius of the second surface are both less than an absolute value of a curvature radius of the fourth surface; a ratio of the curvature radius of the first surface to the curvature radius of the second surface is 0.5 to 1.25; and an absolute value ratio of a conic constant of the first surface to a conic constant of the second surface is no greater than 0.4.

2. The optical system according to claim 1, wherein a distance between two intersection points where the first surface and the second surface intersect with the optical axis is a first distance, a distance between two intersection points where the third surface and the fourth surface intersect with the optical axis is a second distance, the first distance is greater than the second distance; and a ratio of the first distance to a focal length of the optical system is 0.45 to 0.8.

3. The optical system according to claim 1, wherein a ratio of the curvature radius of the first surface to a focal length of the optical system is −1.5 to −2.5, and the conic constant of the first surface is −10 to 10;
a ratio of the curvature radius of the second surface to the focal length and a ratio of a curvature radius of the third surface to the focal length are both −2 to −3, and the conic constant of the second surface and a conic constant of the third surface are both −50 to −30;
a ratio of the curvature radius of the fourth surface to the focal length is −4.5 to −6.5, and a conic constant of the fourth surface is 15 to 35.

4. The optical system according to claim 2, wherein a ratio of the second distance to the focal length of the optical system is 0.12 to 0.25.

5. The optical system according to claim 1, wherein a ratio of an aperture of the lens component to a focal length of the optical system is 2 to 3.

6. The optical system according to claim 1, wherein a ratio of a total track length of the optical system to a focal length of the optical system is 0.8 to 1.

7. The optical system according to claim 1, wherein the phase retardation film is located between the reflective polarization layer and the transflective film, or located on a side of the reflective polarization layer away from the transflective film.

8. The optical system according to claim 1, further comprising:
a linear polarization film, located on a side of the reflective polarization layer away from the transflective film.

9. The optical system according to claim 2, wherein the lens component comprises a first lens, a second lens and a third lens arranged sequentially along the direction of the optical axis; the first lens comprises the first surface, the second lens comprises the second surface, the third lens comprises the third surface and the fourth surface; the first lens further comprises a fifth surface opposite to the first surface, the second lens further comprises a sixth surface opposite to the second surface; the fifth surface and the sixth surface have a same surface type parameter, the fifth surface and the sixth surface are both flat surfaces, or an absolute value of a curvature radius in at least one direction of the fifth surface is greater than an absolute value of a curvature radius of other surfaces;
the phase retardation film is located on the fifth surface or the sixth surface.

10. The optical system according to claim 9, wherein the absolute value of the curvature radius in the at least one direction of the fifth surface is greater than 100 millimeters.

11. The optical system according to claim 9, wherein a distance between two intersection points where two surfaces of the first lens intersect with the optical axis is a third distance, a distance between two intersection points where two surfaces of the second lens intersect with the optical axis is a fourth distance, a distance between two intersection points where two surfaces of the third lens intersect with the optical axis is the second distance, and the second distance and the fourth distance are both less than the third distance.

12. The optical system according to claim 11, wherein a ratio of a sum of the third distance and the fourth distance to the first distance is 0.9 to 1.1.

13. The optical system according to claim 11, wherein a ratio of the third distance to the focal length is 0.35 to 0.5, and a ratio of the fourth distance to the focal length is 0.1 to 0.3.

14. The optical system according to claim 10, wherein a ratio of a center thickness to an edge thickness of the first lens is no less than 0.5 and no greater than 3, and a ratio of an edge thickness to a center thickness of the second lens is no less than 0.5 and no greater than 2.

15. The optical system according to claim 1, wherein an exit pupil distance of the optical system is 12 millimeters to 20 millimeters.

16. The optical system according to claim 9, wherein the first lens and the second lens are made of a same material, and a material of the third lens is different from the material of the second lens.

17. The optical system according to claim 1, wherein the lens component comprises a first lens and a second lens arranged sequentially along the direction of the optical axis; the first lens comprises the first surface and the second surface, and the second lens comprises the third surface and the fourth surface;
the phase retardation film is located between the reflective polarization layer and the transflective film, or located on a side of the reflective polarization layer away from the second surface.

18. The optical system according to claim 17, wherein the phase retardation film is located between the reflective polarization layer and the transflective film; and the reflective polarization layer is configured to reflect linearly polarized light of one characteristic and transmit linearly polarized light of another characteristic; or,
the phase retardation film is located on a side of the reflective polarization layer away from the second surface, and the reflective polarization layer comprises a cholesteric liquid crystal layer.

19. A display apparatus, comprising a display screen and the optical system according to claim 1,
wherein the optical system is located on a display side of the display screen, and the second surface is located on a side of the first surface away from the display screen.
